(19) United States
(12) Patent Application Publication
(10) Pub. No.: US 2026/0356157 A1
(43) Pub. Date: Nov. 12, 2026

(54) SYSTEMS AND METHODS FOR SERVICING THERMAL MANAGEMENT SYSTEMS IN MOTOR VEHICLES

(71) Applicant: THE CHEMOURS COMPANY FC, LLC, WILMINGTON, DE (US)

(72) Inventors: THOMAS JEAN ALBERT MARTIN HERMENS, MEYRIN (CH); REJDI BALLUKU, ANTWERP (BE)

(73) Assignee: THE CHEMOURS COMPANY FC, LLC, WILMINGTON, DE (US)

(21) Appl. No.: 19/124,977

(22) PCT Filed: Dec. 11, 2023
(86) PCT No.: PCT/US2023/083285

§ 371 Date: Apr. 28, 2025

Related U.S. Application Data
(60) Provisional application No. 63/431,766, filed on Dec. 12, 2022.

(51) Int. Cl. B60H 1/00

(52) U.S. Cl. CPC B60H 1/00585; B60H 1/0073; B60H 1/00735; B60H 1/00985

(57) ABSTRACT

Example embodiments disclose a method including receiving a malfunction indication associated with a thermal system of a vehicle, determining whether the malfunction indication is related to servicing the thermal system, determining a multi-tiered service option for servicing the thermal system wherein the multi-tiered service option includes at least one of a mobile service, a micro-site service, or a full-service, selecting one of the multi-tiered service option, wherein the selection is based at least in part on statistical data relating to prior malfunctions associated with the vehicle, and scheduling the selected multi-tiered service option to perform service on the thermal system of the vehicle.

### CROSS REFERENCE TO RELATED APPLICATIONS

This application claims priority to U.S. Provisional Application No. 63/431,766, filed on Dec. 12, 2022, the disclosure of which is herein incorporated by reference in its entirety.

### FIELD OF DISCLOSURE

The present disclosure relates to performing services in motor vehicles, more specifically, performing services to thermal management systems including AC systems in internal combustion engine vehicles or heat pumps in electric vehicles by providing different types of services.

### BACKGROUND

Drivers who are currently experiencing air-conditioning (AC) systems failures have limited options when the vehicle is out of warranty. This is because most AC systems issues are only more common when vehicles are over 7 years old and thus often out of warranty. For internal combustible engines, a typical AC system requires continuous maintenance and/or repairs for recharging the AC system with refrigerant and/or for evacuating and charging oil for a compressor. A poorly functioning AC system will cause the vehicle to operate inefficiently and consume more gas per mile. As for electric vehicles (EV), cooling and heating consume a significant amount of power from an EV battery, impacting driving range and safety. Since air conditioners in EV use the heat generated, via a heat pump compressor, by compressing the refrigerant to heat/cool the air inside the vehicle, the refrigerant reduces the power required for operating the heat pump, thereby freeing up more electricity for the EV to cover a longer distance on a full charge. In addition, the refrigerant loop is directly connected to a drive train and battery cooling loops to exchange thermal energy. A non-working (or limited) refrigerant loop can cause significant damage to the battery pack and in a worst-case scenario lead to a thermal runaway event in the battery pack. As such, there are many gains to be made to make heating/cooling systems more efficient in EV to boost driving range and safety.

Typically, an appointment is made at a non-original equipment manufacturer (OEM) garage where the mechanic will assume the refrigerant level is too low for the AC system or the heat pump to operate normally and perform an “evac and recharge” (i.e., top-off) service. In many cases this is indeed the most common cause of the issue. However, in about 40% of the cases, this approach will not work and further trouble shooting, or extensive service will be required. The garage will often not have the skilled technicians and/or equipment to handle this work, which is a time consuming and costly process. The garage will therefore often send the customer to another garage for a more detailed trouble shooting and focus on just the refrigerant top-up service. This creates significant frustration with drivers who are facing a more difficult AC system issue. Accordingly, there are currently no top-up recharging service locations that can perform the trouble shooting full-service. Additionally, there are very few garages that provide a dedicated/focused service for AC system for motor vehicles, in particular, a specialist in the market that can handle AC systems, i.e., heat pumps for EV, which will become more widespread in the near future as EVs will represent a major portion of car fleets.

Therefore, there is a need in the art for systems and methods that do not suffer from the above shortcomings.

### SUMMARY

In an example embodiment, a method includes receiving a malfunction indication associated with a thermal system of a vehicle, determining whether the malfunction indication is related to servicing the thermal system, determining a multi-tiered service option for servicing the thermal system wherein the multi-tiered service option includes at least one of a mobile service, a micro-site service, or a full-service, selecting one of the multi-tiered service option, wherein the selection is based at least in part on statistical data relating to prior malfunctions, age, brand, mileage as well as associated history with the vehicle, and scheduling the selected multi-tiered service option to perform service on the thermal system of the vehicle.

In another example embodiment, a method includes receiving a determination of malfunction of a thermal system of a vehicle, receiving information associated with the vehicle, providing a multi-tiered service option for servicing the thermal system of the vehicle, selecting a type of service option among the multi-tiered service option, wherein selecting the type of service option is based at least in part on the vehicle comprising a minor service or a major service, and determining a schedule associated with the selected service option

In yet another example embodiment, a system including one or more processors, and one or more non-transitory computer readable storage media communicatively coupled to the one or more processors and storing instructions that are executable by the one or more processors to receive a malfunction indication associated with a thermal system of a vehicle, determine whether the malfunction indication is related to servicing the thermal system, determine a multi-tiered service option for servicing the thermal system wherein the multi-tiered service option includes at least one of a mobile service, a micro-site service, or a full-service, selecting one of the multi-tiered service option, wherein the selection is based at least in part on statistical data relating to prior malfunctions associated with the vehicle, and schedule the selected multi-tiered service option to perform service on the thermal system of the vehicle.

In yet another example embodiment, system, including one or more processors, and one or more non-transitory computer readable storage media communicatively coupled to the one or more processors and storing instructions that are executable by the one or more processors to receive a malfunction indication associated with a thermal system of a vehicle, determine whether the malfunction indication is related to servicing the thermal system, determine a multi-tiered service option for servicing the thermal system wherein the multi-tiered service option includes at least one of a mobile service, a micro-site service, or a full-service, selecting one of the multi-tiered service option, wherein the selection is based at least in part on statistical data relating to prior malfunctions associated with the vehicle, and schedule the selected multi-tiered service option to perform service on the thermal system of the vehicle.

Other features and advantages of the present invention will be apparent from the following more detailed description, taken in conjunction with the accompanying drawings which illustrate, by way of example, the principles of this disclosure.

### BRIEF DESCRIPTION OF THE DRAWINGS

FIGS. 1A-1D illustrate pictorial flow diagrams of example processes for vehicle diagnostic and maintenance of AC systems service, according to an example embodiment.

FIG. 2 illustrates an example architecture for automated vehicle diagnostics and scheduling of AC systems service, according to an example embodiment of the present disclosure.

FIGS. 3-6 illustrate exemplary processes according to example embodiments of the present disclosure.

FIG. 7 is a schematic diagram illustrating attributes of the present methods, apparatuses, and systems.

FIG. 8 illustrates an exemplary diagnostic decision process in accordance to an example embodiment of the present disclosure.

FIG. 9 is a schematic diagram of a computer system in accordance to an example embodiment of the present disclosure.

Wherever possible, the same reference numbers will be used throughout the drawings to represent the same parts.

### DETAILED DESCRIPTION OF EXAMPLE EMBODIMENTS

The present disclosure relates to an AC system service solution for a combustion engine vehicle and/or an electric vehicle (EV) with a multi-tier offering, i.e., an in-depth service, a micro location service, and a mobile service, based on statistical analysis. This provides a process with comprehensive statistical understanding of typical problems per vehicle type and usage profile to make an appropriate and accurate course of action to resolve the AC system issues. This “more in-depth knowledge” will provide a significant long term competitive advantage as it provides an inherent long term cost advantage to vehicle owners. In addition, the present AC system service solution ensures credibility where there is assurance that the service will meet higher standards.

Additionally, the present disclosure aims to provide focused and qualitative AC system service driven by data collection via a diagnostics engine. The diagnostics engine processes the collected data across a wide spectrum of parameters, such as, but not limited to, geographies, brands, technologies, production years, usages cycles, etc. of the vehicle, and provides an expeditious and optimized solution for a vehicle owner or a fleet owner. The diagnostic engine can further process the data collection on a micro scale, apply macro rules statistical rules, and export micro guidelines to be used contemporaneously and/or in the future for learning, improving maintenance work and procedures, improving systems condition, and/or user satisfaction.

In some implementations, vehicle owners will receive a diagnostic and cost estimate output from the diagnostic engine after answering a set of questions. After the diagnostics output, the user will receive an appointment proposal either in one of: micro centers, in-depth centers in a network, or mobile centers (e.g., mobile van), where the diagnosis will be verified, and proposed work executed. The interaction with the user and work coordination can be managed by a web-based interface or a mobile application. In addition to the maintenance service, the user is made aware of additional services that the user can qualify for based on the statistical data.

In some implementations, the present disclosure describes methods, apparatuses, and systems of a fully integrated AC systems service associated with user interaction, diagnostics capability, maintenance capability, statistical decision capacity, and closed loop supply chain capacity via recycling, reclaiming and retrofitting.

Some advantages or improvements relating to the present disclosure ensures easy management to keep AC systems of vehicles in top working conditions, improving gas mileage or extending driving range for EV, hence, reducing cost for gas or electricity, respectively. The present disclosure further provides a time efficient on-demand access to AC service, which is currently unavailable. Moreover, maintaining a ‘healthy’ AC system of vehicles mitigate the risk of larger future AC maintenance issues, thus protecting the user and the environment.

Vehicles to be serviced can include any motor vehicles related to passenger vehicles, commercial vehicles, such as buses, vans, trucks, off-highway vehicles, among other commercial and passenger transportation systems. These vehicles can be of a conventional combustible engine vehicle or an electric vehicle (EV).

The methods, apparatuses, and systems described herein can be implemented in a number of ways. Example implementations are provided below with reference to the following figures. Although discussed in the context of a vehicle driven by an individual, the methods, apparatuses, and systems described herein can be applied to an owner of a fleet of vehicles and are not limited to vehicles discussed herein. Further, although the operations can be described with respect to one particular type of vehicle service, i.e., AC systems servicing, the operations discussed herein can be applied to any type of repairs, services, or offerings.

As described herein, the term “AC systems” describes components (e.g., a compressor, a condenser, an evaporator, an expansion valve, refrigerant, etc.) of an internal combustible engine or electric vehicle or components (e.g., heat pump) for temperature control and/or or a battery of an electric vehicle. Further, the term “thermal system” relates to AC systems relating to internal combustible engine vehicles or EVs.

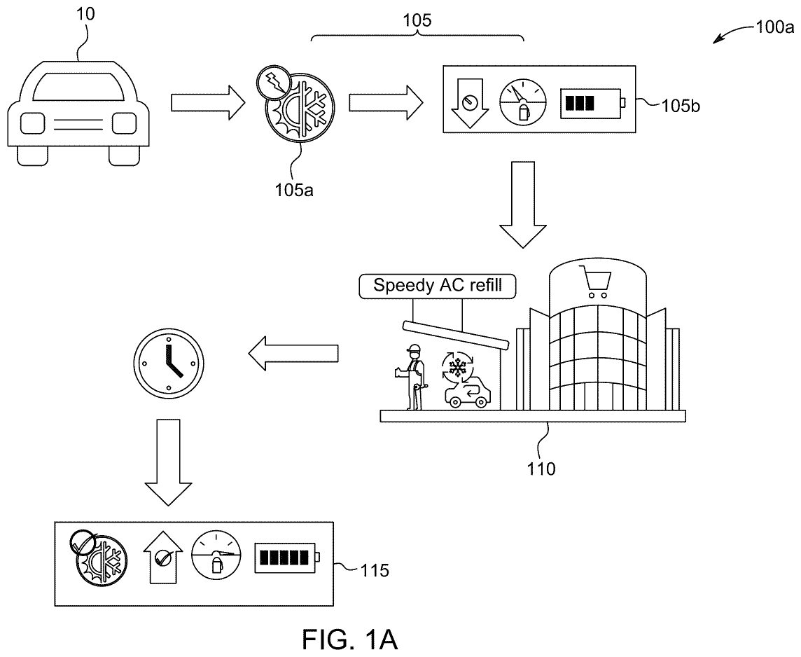

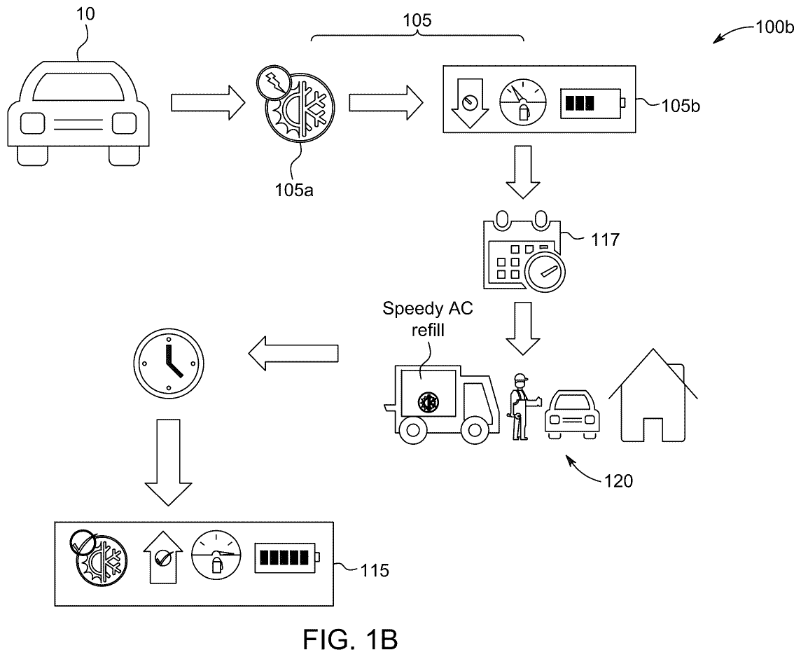

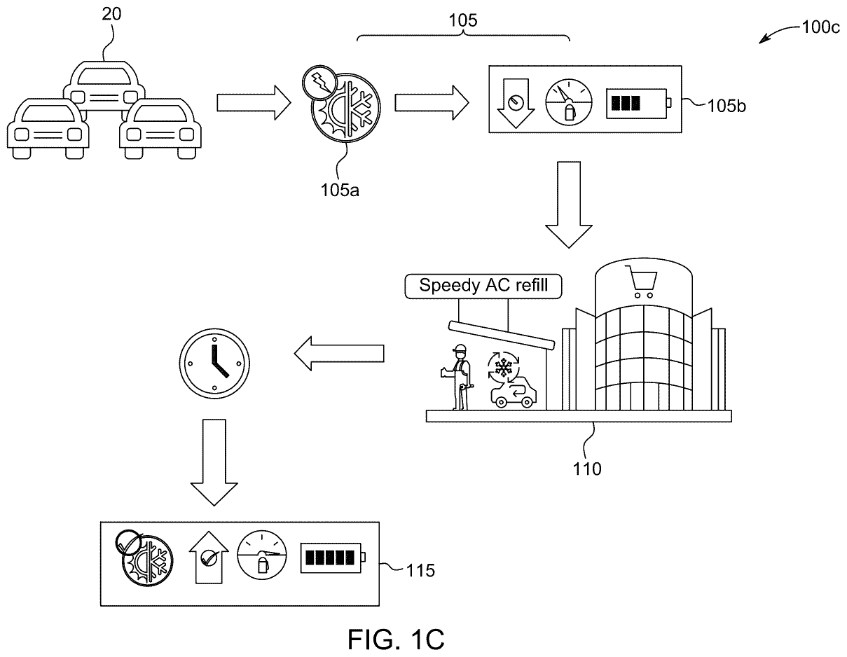

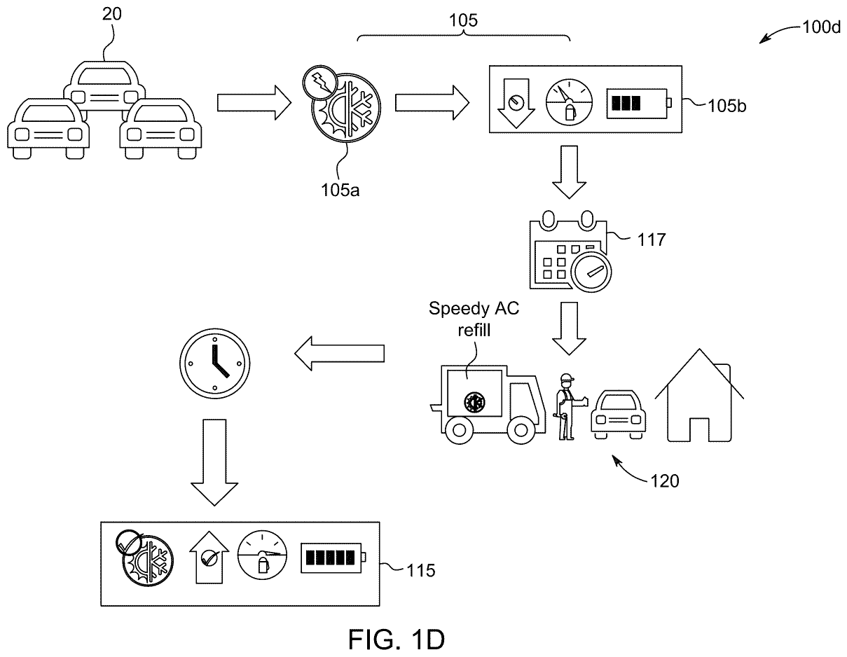

FIG. 1A illustrates a pictorial flow diagram of an example process 100a for vehicle diagnostic and maintenance of AC systems service, according to an example embodiment.

At step 105, the process 100a includes determining a malfunction (105) relating to AC systems of a vehicle 10. In one implementation, the malfunction can be determined when a user determines that the AC systems of the vehicle 10 is not functioning properly and/or the vehicle 10 makes abnormal noise and/or vibration (105a). For example, windows inside of the vehicle 10 are not defogging and/or not cooling/heating very well. In other implementations, the malfunction can be determined when an error message is displayed in the vehicle 10 indicating performance issue(s) relating to the AC systems (105b). For example, gas fuel efficiency is low, cabin temperature is low, battery efficiency is low, etc. When the malfunction of the AC systems is determined, the user will communicate with a service location (e.g., garage, auto repair shop, dealership, etc.) to obtain service. In some implementations, an interface for communication can be a mobile application, text message and/or call to the service location. In case of a complicated malfunction, the user is instructed to download an app for further instructions. In case the communication would simply consist of making an appointment for maintenance in one of the service locations, calling or texting would be sufficient. In the outset, the user provides some basic information regarding the vehicle, such as, but not limited to, model, year, milage, address details, description of the problem, and past maintenance history of the AC system, in order to make an appointment. In some implementations, this information can be captured by a web-based interface and/or a mobile app. If this initial information indicates a high likelihood of a low refrigerant level, i.e., leak, requiring just a ‘top-up’ service, the user will be instructed to make an appointment for a visit to a micro-site in a public location, step 110. In some implementations, the micro-site location is at a fixed location capable of addressing minor AC systems issues. In some implementations, the micro-site location can be at a shopping mall parking garage, dedicated garages, office locations, or other highly trafficked facilities. As an exemplary illustration, the user drops the vehicle 10 at a shopping mall parking garage for AC system service (i.e., top-up service) and shops around for approximately one hour while the vehicle is serviced or repaired. After the service at the micro-site location, the AC system of the vehicle 10 is fully charged and ready for proper operation, step 115.

In other implementations, in process 100c, the vehicle to be serviced can be among a fleet of vehicles 20 owned by a single entity, as shown in FIG. 1C.

When there is a malfunction associated with the AC systems of one of the fleet vehicles 20, the vehicle fleet user makes an appointment to the micro-site location for servicing (i.e., a top-up service), at step 110. Similar to FIG. 1A, the user can shop or wait near the micro-site location while the fleet vehicle 20 is serviced or repaired. After the service, the AC system of the fleet vehicle 20 is fully charged and ready for proper operation, at step 115.

FIG. 1B illustrates a pictorial flow diagram of an example process 100b for vehicle diagnostic and maintenance of AC systems, according to another example embodiment. Unlike the implementation described in FIG. 1A, the process 100b of FIG. 1B illustrates a mobile service where the vehicle service can be scheduled to be performed in a field (i.e., at a remote location) designated by the user, at step 120.

For example, the mobile location can be at home, office, or any other designated location. In this exemplary embodiment, when the received information indicates a low refrigerant level, requiring just a ‘top-up’ service, the user will be instructed to make an appointment (step 117) for a technician to directly come out to the desired location to perform the AC system service, step 120. In some implementations, the mobile service includes a mobile unit (e.g., mobile van) having at least a recharge, recover, recycle machine equipped with refrigerant, such as R134a, R1234yf, blends thereof, among any other refrigerants having ASHRAE registrations, built within the mobile unit for servicing the AC systems. By way of example, the user makes an appointment via mobile app or text with the service location for a technician to come out to the user's home for service. Some services by the mobile unit include performing refrigerant top-ups, collecting the AC systems “health condition” information (e.g., mileage, age, maintenance history, consumption which can be collected, for example, via an on-board computer fault messages), replacing parts, performing trouble shooting in certain cases to diagnose the problem, and/or performing minor repairs. After the service by the technician, the AC system of the vehicle 10 is fully charged and ready for proper operation, at step 115.

Another embodiment relates to a mobile service which includes a mobile unit (e.g., mobile van) having at least a recharge, recover, recycle machine equipped with an E-1,3,3,3-tetrafluoropropene (HFO-E-1234ze) composition containing E-1,3,3,3-tetrafluoropropene in an amount of 50.0 wt. % or more, preferably in an amount of 75.0 wt. % or more, more preferably in an amount of 99.0 wt. % or more, even more preferably in an amount of 99.5 wt. % or more, and most preferably in an amount of 99.8 wt. % or more, based on the total weight of the fluoropropene composition.

Another embodiment relates to a mobile service which includes a mobile unit (e.g., mobile van) having at least a recharge, recover, recycle machine equipped with an E-1,3,3,3-tetrafluoropropene (HFO-E-1234ze) composition containing E-1,3,3,3-tetrafluoropropene, as disclosed herein, which additionally comprises 2,3,3,3-tetrafluoropropene and 1,1,3,3,3-pentafluoropropene, wherein the total amount of 2,3,3,3-tetrafluoropropene and 1,1,3,3,3-pentafluoropropene in the fluoropropene composition is 0.001 to 0.9 wt. %, preferably is 0.1 to 0.8 wt. %, and most preferably is 0.3 to 0.5 wt. %, based on the total weight of the fluoropropene composition.

Another embodiment relates to a mobile service which includes a mobile unit (e.g., mobile van) having at least a recharge, recover, recycle machine equipped with an E-1,3,3,3-tetrafluoropropene (HFO-E-1234ze) composition which additionally comprises R-134, preferably in an amount of 1.0 to 40.0 wt. %, more preferably in an amount of 30.0 to 40.0 wt. %, and most preferably in an amount of 35.0 to 40.0 wt. % based on the total weight of the fluoropropene composition.

Another embodiment relates to a mobile service which includes a mobile unit (e.g., mobile van) having at least a recharge, recover, recycle machine equipped with an E-1,3,3,3-tetrafluoropropene (HFO-E-1234ze) composition which additionally comprises R-1336mzzE and/or R-227ea, preferably in an amount of 15.0 to 20.0 wt. % of R-1336mzzE and of 2.0 to 5.0 wt. % of R-227ea, based on the total weight of the fluoropropene composition.

Another embodiment relates to a mobile service which includes a mobile unit (e.g., mobile van) having at least a recharge, recover, recycle machine equipped with a composition comprising E-1,3,3,3-tetrafluoropropene (HFO-E-1234ze) and HFC-227ea. In one embodiment, the composition comprises HFO-E-1234ze and up to 15 wt. % HFC-227ea, preferably from 8 to 13 wt. % HFC-227ea, based on the total weight of the composition. In one embodiment, the composition comprises 88 wt. % HFO-E-1234ze and 12 wt. % HFC-227ea, based on the total weight of the composition. In one embodiment, the composition comprises 91.1 wt. % HFO-E-1234ze and 8.9 wt. % R-227ea, based on the total weight of the composition.

Another embodiment relates to a mobile service which includes a mobile unit (e.g., mobile van) having at least a recharge, recover, recycle machine equipped with a composition comprising HFO-E-1234ze and HFC-152a. In one embodiment, the composition comprises HFO-E-1234ze and up to 20 wt. % HFC-152a, preferably from 1 to 20 wt. % HFC-152a, based on the total weight of the composition.

Another embodiment relates to a mobile service which includes a mobile unit (e.g., mobile van) having at least a recharge, recover, recycle machine equipped with a composition comprising HFO-E-1234ze, HFC-32, and HFC-152a. In one embodiment, the composition comprises HFO-E-1234ze and up to about 15 wt. % HFC-32 and up to about 10 wt. % HFC-152a, based on the total weight of the composition. In one embodiment, the composition comprises 83 wt. % HFO-E-1234ze, 12 wt. % HFC-32 and 5 wt. % HFC-152a, based on the total weight of the composition.

Another embodiment relates to a mobile service which includes a mobile unit (e.g., mobile van) having at least a recharge, recover, recycle machine equipped with a composition comprising HFO-E-1234ze, HFC-32, and HFC-134a. In one embodiment, the composition comprises HFO-E-1234ze and up to about 10 wt. % HFC-32 and up to about 50 wt. % HFC-134a, based on the total weight of the composition. In one embodiment, the composition comprises 49 wt. % HFO-E-1234ze, 6 wt. % HFC-32 and 45 wt. % HFC-134a, based on the total weight of the composition.

Another embodiment relates to a mobile service which includes a mobile unit (e.g., mobile van) having at least a recharge, recover, recycle machine equipped with a composition comprising HFO-E-1234ze, CO₂, and HFC-134a. In one embodiment, the composition comprises HFO-E-1234ze and up to about 10 wt. % CO₂ and up to about 15 wt. % HFC-134a, based on the total weight of the composition. In one embodiment, the composition comprises 85 wt. % HFO-E-1234ze, 6 wt. % CO₂ and 9 wt. % HFC-134a, based on the total weight of the composition.

In one embodiment, the composition is one of R-444A, R-445A, R-456A, R515A and R-515B.

Another embodiment relates to a mobile service which includes a mobile unit (e.g., mobile van) having at least a recharge, recover, recycle machine equipped with an E-1,3,3,3-tetrafluoropropene composition which additionally and optionally comprises one or more of R-143a, R-152a, TFP (trifluoropropyne), R-1233xf, R-1233zd(E), R-1233zd(Z), R-236fa, and at least one HFO-1234 isomer including at least one of HFO-1234zc, HFO-1234yc and HFO-1234ye.

Another embodiment relates to a mobile service which includes a mobile unit (e.g., mobile van) having at least a recharge, recover, recycle machine equipped with an E-1,3,3,3-tetrafluoropropene composition in which the sum total additional compounds selected from one or more of R-143a, R-152a, TFP, R-1233xf, R-1233zd(E), and R-1233zd(Z) is present in amounts of between 0.001 mole percent and 2 mole percent, based on the total fluoropropene composition.

In some embodiments, any of the compositions disclosed herein further comprises an effective amount of at least one inhibitor which reduces conversion of the fluoroolefin (e.g., HFO-1234ze(E) or HFO-1234yf) into oligomers or polymers.

The composition preferably contains less than 1 wt. % of oligomeric, homopolymers or other polymeric products, preferably less than about 0.03 wt. % of oligomeric, homopolymers or other polymeric products. In one embodiment, the inhibitor comprises at least one member selected from limonene, α-terpinene, α-tocopherol, butylated hydroxytoluene, 4-methoxyphenol, and benzene-1,4-diol, preferably at least one of limonene and α-terpinene. In one embodiment, the inhibitor is present in an amount of about 30 to about 3,000 ppm.

In one embodiment, any of the compositions disclosed herein further comprises, in addition to the inhibitor, an anti-oxidant selected from butylated hydroxyanisole, tertiary-butylhydroquinone, gallate, 2-phenyl-2-propanol, 1-(2,4,5-trihydroxyphenyl)-1-butanone, phenolics, bisphenol methane derivatives, and 2,2′-methylene bis (4-methyl-6-t-butyl phenol).

In one embodiment, any of the compositions disclosed herein further comprises, in addition to the inhibitor and anti-oxidant, at least one member selected from air, oxygen, cumene hydroperoxide, and fluoroolefin polyperoxides, peroxides, hydroperoxides, persulfates, percarbonates, perborates and hydropersulfates.

In some implementations, in process 100d, the mobile unit or multiple mobile units can be transported to a location where multiple fleets of vehicles are located for service, as shown in FIG. 1D. This provides a higher repair capacity by the mobile unit(s) when concerning a fleet of vehicles. In other words, the technician can perform service to the fleet of vehicles at a single location as compared to when the technician visits single vehicles at various locations. In one implementation, the mobile unit(s) can drive to a parking lot where multiple fleet vehicles are parked for service. Similar to FIG. 1B, when there is a malfunction associated with the AC systems of one or several fleet vehicles 20, the fleet owner makes an appointment for the technician to come directly to the location of the fleet vehicles 20, designated by the fleet owner, at step 120. After the service, the AC systems of the fleet vehicles 20 are maintained and ready for proper operation, at step 115.

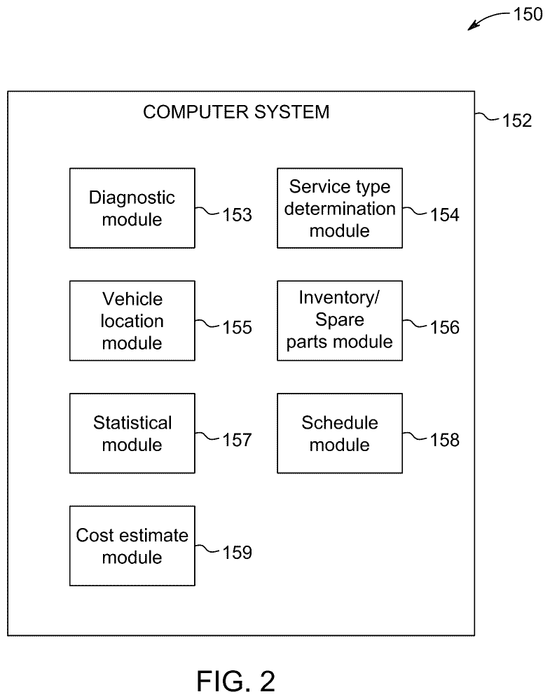

FIG. 2 illustrates an example architecture 150 for automated vehicle diagnostics and scheduling of AC systems service, as described herein. For example, the architecture 150 can include one or more computer system(s) 152 including various hardware and/or software to implement aspects of the systems, methods, and apparatuses described herein. For example, the computer system(s) 152 can include a diagnostic module 153, a service type determination module 154, a vehicle location module 155, an inventory/spare parts module 156, a statistical module 157, a schedule module 158, and a cost estimate module 159.

In some implementations, the computer system(s) 152 can be embodied as a central server that receives inputs from one or more vehicles. In some implementations, the computer system(s) 152 can be embodied in a vehicle. In some implementations, the computer system(s) 152 can further provide perception and planning functionality for the vehicle and can capture any data as discussed herein.

The diagnostic module 153 can include functionality and operation to determine the diagnostic condition associated with the vehicle. For example, the diagnostic module 153 can process basic information relating to the vehicle (e.g., year, make, model, etc.). After processing the basic information of the vehicle, the diagnostic module 153 can process a determination of malfunctioning of AC systems of the vehicle. That is, the diagnostic module 153 can process whether the malfunction is related to operation of the AC systems, i.e., whether cold air is blowing properly or defogging properly, due to insufficient refrigerant, component(s) failure, electronic malfunction and so on. In another example, the diagnostic module 153 can process whether the AC systems malfunction is related to whether the blown cold air is at a reduced rate or higher temperature. In yet another example, the diagnostic module 153 can process whether the AC systems malfunction is related to the vehicle being in a frontal accident or an impediment (e.g., stone, car debris, etc.) that struck the vehicle. In addition, the diagnostic module 153 can process the malfunction of the AC systems based on the vehicle's condition indicators, such as, but not limited to, a fuel efficiency indicator, a temperature indicator, a battery charge indicator, etc. In some implementations, the diagnostic module 153 can store information associated with the vehicle for future diagnose which can be maintained by a technician or a service location. In another implementation, the module will save the profile of an individual vehicle and identify other cars with the same profile, and which are likely to need the same service or repair.

In some implementations, the diagnostic module 153 can process the malfunction for AC systems relating to a type of vehicles, i.e., whether the vehicle is an internal combustible engine vehicle or an EV. For example, the diagnostic module 153 can process whether an engine or electricity is powering a compressor for cooling. As for heating, the diagnostic module 153 can process whether the heating system draws heat from the engine's coolant for internal combustible engine vehicle or uses a battery for a heater matrix with an electric heater for EV.

The service type determination module 154 can include functionality and operation to determine a type of service associated with AC systems service that is required for the vehicle. In some implementations, the type of service includes at least three types: a mobile service, a micro-site location service, and an in-depth location service. The mobile service and the micro-site location service can be determined for minor work AC systems service, such as, for example, a top-up service to replace and refill the refrigerant. Alternatively, for major work AC systems service requiring extensive equipment and/or expert technicians, the in-depth location service will be provided or recommended. Some examples requiring major work AC systems service or repairs are thermostat calibration, equipment conditioning, blower components repairs or replacement, air handler/furnace repairs or replacement, electrical connections repairs or replacement, condenser and evaporator coils repairs or replacement, airflow, safety controls repairs or replacement, and AC compressor repairs or replacement for EV.

The vehicle location module 155 can include functionality to receive data associated with a location of the vehicle. In some instances, the vehicle location module 155 can receive information associated with the vehicle to determine the location of the vehicle for mobile service. In one implementation, the vehicle location module 155 receives the location of the vehicle via GPS, for example and provides navigation instructions to the location of the vehicle associated with servicing the vehicle. In some implementations, the vehicle location module 155 can track the location of the vehicle to instruct the user of the closest micro-site location(s) and/or in-depth service location(s) for servicing. In most instances, the instructions can be based in part to minimize travel time and/or vehicle downtime.

The inventory/spare parts module 156 include functionality and operation to determine inventory of parts for AC systems servicing. In some instances, the inventory/spare parts module 156 can deploy the technician to a location of a vehicle is to be serviced with a particular part(s) to service the AC systems having a specific issue. In some implementations, the inventory/spare parts module 156 can include functionality to instruct the technician to pick up or deliver inventory items and/or tools or equipment.

The statistical module 157 can include functionality to receive data associated to track the vehicle performance over time. In some instance, the statistical module 157 can receive raw sensor data from the vehicle, metadata or determinations based at least in part on sensor data from the vehicle, and/or indications from the user. In some implementations, the statistical module 157 can receive state information associated with the vehicle to determine AC systems conditions associated with the vehicle over time. In one example, the statistical module 157 can provide a comprehensive statistical understanding of the typical problems per vehicle type and usage profile to make an appropriate and accurate course of action to resolve the AC system issues. This enables a more in-depth knowledge by providing a significant long term ‘fix’ which provides an inherent long term cost advantage to vehicle owners (e.g., a fix by having identified and solved the root cause of the given issue). In addition, the statistical module 157, can further process the data collection on a micro scale, apply macro rules statistical rules, and export micro guidelines to be used in the future for learning, improving maintenance work and procedures, improving systems condition, and/or user satisfaction.

In some implementations, the statistical module 157 can include one or more machine learning algorithms and/or heuristic technologies to determine the problems based on the data discussed herein. Further, in some instances, the statistical module 157 can access a database where vehicle behavior(s) are mapped to service issues. In some instances, the one or more machine learning algorithms can include a neural network. As described herein, an exemplary neural network is a biologically inspired algorithm which passes input data through a series of connected layers to produce an output. One example of a neural network can include a convolutional neural network (CNN). Each layer in a CNN can also include another CNN or can include any number of layers. As can be understood in the context of this disclosure, a neural network can utilize machine learning, which can refer to a broad class of such algorithms in which an output is generated based on learned parameters.

In some implementations, the schedule module 158 can process scheduling for appointments based on the type of service. For example, if the schedule module 158 determines a micro-site location service or a mobile service is required (e.g., top-up service), the schedule module 158 processes a date and time and location of the micro-site location for servicing the vehicle. In some implementations, the schedule module 158 can provide the quickest route or direction to the micro-site location. In case of mobile service, the schedule module 158 processes a date and time and location for the technician to arrive at the user's designated location. In some implementations, the schedule module 158 can provide the quickest route or direction to the user's location. If the schedule module 158 determines the in-depth location service is required, after processing a series of questions by the diagnostic module 153, the schedule module 158 processes a date and time and location of the in-depth service and communicated to the user. In some implementations, the schedule module 158 can provide the quickest route or direction to the in-depth location service.

In some implementations, the cost estimate module 158 can send a cost estimate after answering a set of questions, after the diagnostic module 153 diagnosed processed the malfunction. The interaction with the user and cost estimate can be managed by a web-based interface or a mobile application. In some implementations, the cost estimate module 158 can send additional services that the user may need based on statistical data. For example, additional (optional) services may include refill of compressor oil, air filtration cleaning or replacement, fuse replacement, thermostat replacement, deep anti-bacterial cleaning, etc. In some implementations, the cost estimate module 158 can process financial transactions, such as sales, purchases, receipts, and payments, relating to the AC systems service.

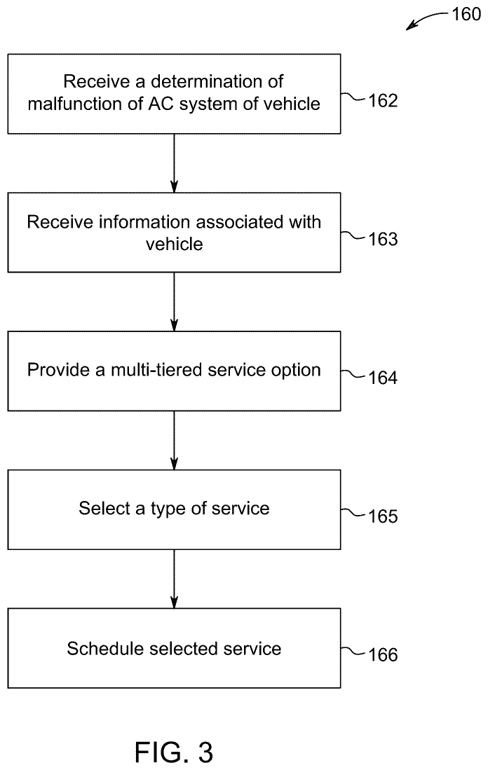

FIGS. 3-6 illustrate example processes in accordance with embodiments of the disclosure. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

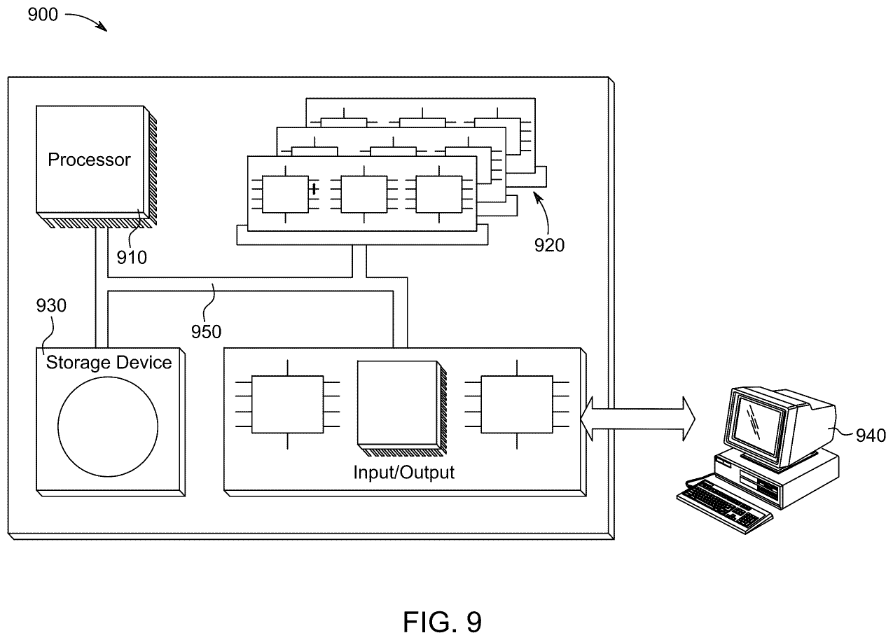

FIG. 3 depicts an example process 160 for determining a malfunction of AC systems for servicing and selecting a type of service to perform servicing on a vehicle. For example, some or all of the process 160 can be performed by one or more components in the architecture 150, or in an environment 900 (FIG. 9), as described later herein.

At operation 162, the process can include receiving data, one or more user indications, and/or one or more error codes associated with AC systems of the vehicle. In some implementations, the operation 162 can include receiving a determination from the user or can include receiving a determination directly from the vehicle of the AC systems service issue. For example, operation 162 can receive the determination that the operation of the AC systems is malfunctioning, i.e., warm air is blowing or defogging not working properly, via user's interaction. In other examples, the determination can be made if the user's interaction indicates that the cold air is at a reduced rate or not at a predetermined temperature. In yet another example, the determination can be made if a sensor on the vehicle indicates that the vehicle was in a frontal accident or an impediment (e.g., stone, car debris, etc.) struck the vehicle causing the malfunction. In some implementations, operation 162 can include receiving one or more indications (user's interaction) from the user, such as from a computing device operating in conjunction with the vehicle, and/or from an application operating on a computing device associated with the user (e.g., a smartphone).

In some implementations, operation 162 can receive the determination directly from the vehicle associated with the AC systems based on the vehicle's condition indicators, such as, but not limited to, a fuel efficiency indicator, a temperature indicator, a battery charge indicator, etc. In some instances, the vehicle can automatically determine the AC systems service issue and provide the indication as an error code corresponding to the service issue.

At operation 163, the process can include receiving basic information associated with the vehicle for statistical data. For example, the basic information can be related to year, make, model, and mileage of the vehicle. In some implementations, the basic information can be received by a service central (e.g., garage, auto repair shop, dealership) regarding the malfunction of AC systems to determine a course of action. For example, based on the basic information in conjunction with statistical data, operation 163 can process that the malfunction is related to a refrigerant leak requiring a top-up service.

At operation 164, the process can include providing a multi-tiered service option for servicing the AC systems of the vehicle. In some implementations, the multi-tiered service option can be of a mobile service option, a micro-site service option, and an in-depth full-service option. The mobile service option and the micro-site location service option can be performed for minor work AC systems service, such as, for example, a top-up service to replace and refill the refrigerant. In some implementations, the micro-site location is at a fixed location capable of addressing the aforementioned minor work AC systems service. For example, the micro-site location can be at a shopping mall parking garage, dedicated garages, office locations, or other highly trafficked facilities. In some implementations, the mobile service option can be performed in a field (i.e., at a mobile location) designated by the user. For example, the mobile service option can be performed at home, office, or any other designated location. For major work AC systems service requiring further evaluation, the in-depth location service option will be provided or recommended.

At operation 165, the process can include selecting one of the multi-tiered options received by the user. In some implementations, the option of micro-site service option or mobile service option will be selected when the malfunction is associated with minor AC systems issues, e.g., low refrigerant level requiring a ‘top-up’ service. In other implementations, the option of in-depth full-service option will be selected when the malfunction is associated with major AC systems issues or complicated problem requiring extensive equipment and expert technicians.

At operation 166, the process can include scheduling one of the selected options for service. For example, the option of micro-site service option can include contacting the service center and arranging an appointment for service.

Alternatively, the micro-site service option can include visiting the service central without scheduling an appointment. For example, the user may visit the micro-site location and wait for service. For the option of mobile service option, the user can schedule the appointment and designate a location for service via a computing device associated with the user (e.g., a smartphone). For the option of in-depth service option, the user can schedule the appointment directly with service center via a computer device associated with the user or call the service center.

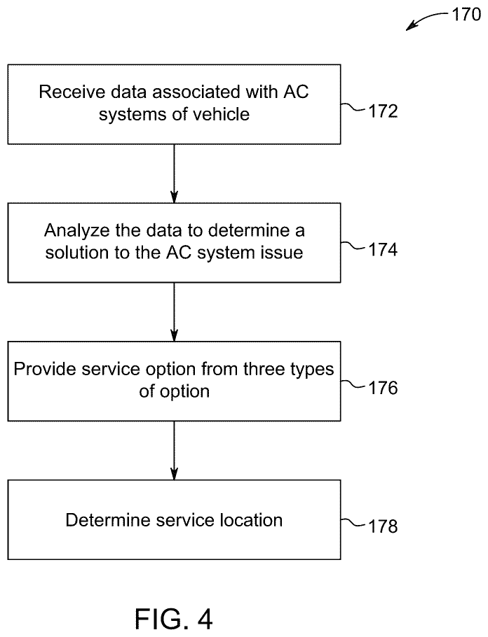

FIG. 4 depicts an example process 170 for determining a service location based on a selected type of service. For example, some or all of the process 170 can be performed by one or more components in the architecture 150, or in the environment 900, as described later herein.

At operation 172, the process can include receiving data associated with the AC systems malfunction of the vehicle. In some implementations, the operation 172 can include receiving information from the user indicating the malfunctioning AC system. For example, the user can transmit information, via a smartphone, for example, to the service center indicating the AC systems is malfunctioning. For example, the temperature of the air blowing is not at the predetermined temperature and/or the front window is not defogging properly. In other implementations, operation 172 can include receiving the raw sensor data associated with AC systems of the vehicle, metadata associated with sensor data from the vehicle, error code(s) from the vehicle, or any data associated with the AC systems of the vehicle.

At operation 174, the process can include analyzing the data to determine likely issues of malfunction and recommend a solution based on the data. For example, if data indicates the make, year, model and mileage of the vehicle, operation 174 can make a determination that a top-up service is required or due for recharging based on the make, year, model or mileage of the vehicle. In another example, if data indicates that the temperature of the blown air is not at its predetermined temperature or the window is not properly defogging, operation 174 can make a determination that the AC systems may just require a top-up service or require a further evaluation. In yet another example, if data indicates that the AC systems in not working at all, operation 174 can make a determination that the AC systems is need of an expert technician for a full-service evaluation. In some implementations, operation 174 can make a determination based on the raw sensor data associated with AC systems of the vehicle, metadata associated with sensor data from the vehicle, error code(s) from the vehicle, or any data associated with the AC systems of the vehicle. For example, if data received indicating a low coolant level from a coolant indicator, operation 174 can make a determination that a top-up service is required or due for recharging. In another example, if data received indicating a low battery charge from a battery indicator of the EV, operation 174 can make a determination that a top-up service is required or due for recharging. It should be appreciated that the processes are not mutually exclusive and may be used in conjunction with each other processes. As described above, in some examples various machine learning algorithms (such as artificial neural networks, linear or logistic regression, and the like) may be used to provide such determinations.

At operation 176, the process can include providing a service option from three types of options based on the determined data at operation 174. For example, if a top-up service is determined, operation 176 can process either a mobile service or a visit to a micro-site center service. In another example, if a full-service is determined, operation 176 can process an in-depth center service to fully service the vehicle.

At operation 178, the process can include determining a service location.

In some implementations, operation 178 can arrange a schedule to service the vehicle to the service location. In the mobile service options, the user makes an appointment with a technician and designates the location. In the micro-site center service, the user visits the micro-site center and may wait for the vehicle to be serviced. It is also possible that the user may arrange an appointment prior to visiting the micro-site center for efficient process. In the in-depth service option, the user makes an appointment to the service center after answering a series of questions regarding the malfunction of the AC systems. In some implementations, the user may wait in the in-depth service center or may drop the vehicle off.

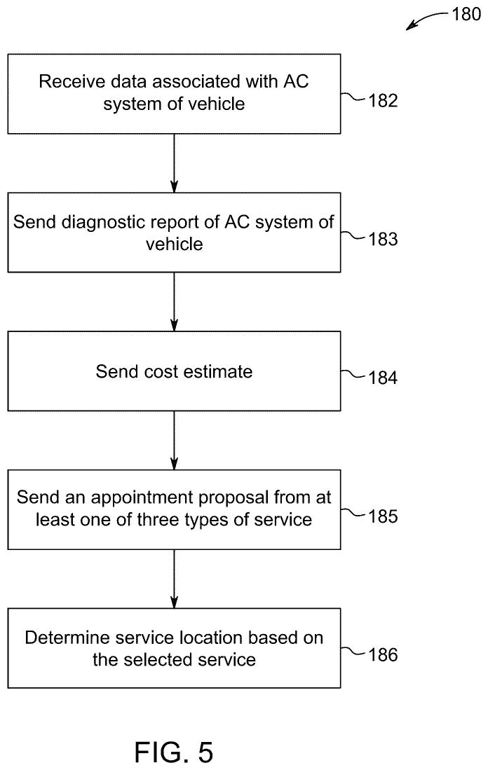

FIG. 5 depicts an example process 180 for determining a service location based on a selected type of service. For example, some or all of the process 170 can be performed by one or more components in the architecture 150, or in the environment 900, as described later herein.

At operation 182, the process can include receiving data associated with AC systems of the vehicle. In some implementations, operation 182 include receiving a determination from the user or can include receiving a determination directly from the vehicle of the AC systems service issue.

At operation 183, the process can include sending a diagnostic report of the AC systems based on the received data. In some implementations, the diagnostic report can include the vehicle information. For example, the diagnostic report can include the year, make, model, mileage and location of the vehicle. In some implementations, the diagnostic report can include a condition (operational function) of the AC systems. For example, the diagnostic report can include the refrigerant level, performance level of the condenser, performance level of the evaporator, air flow of air intake, power level of electrical charge for EV, etc. In some implementations, the diagnostic report can include a physical condition of the vehicle. For example, the diagnostic report can include if any damage to the front of the vehicle is presented from an accident or an impediment (e.g., stone, car debris, etc.) that struck the vehicle.

At operation 184, the process can include sending a cost estimate based on the diagnostic report. In some implementations, operation 184 may include several cost estimates based on different service types.

At operation 185, the process can include sending an appointment proposal from at least one of three types of service, e.g., a mobile service, a mobile-site service, and an in-depth service. In some implementations, the appointment can be made directly with the service center or made via electronically. For example, the appointment can be made from a web-based interface, a mobile application, or text.

At operation 185, the process can include determining a service location center based on the selected service. For the micro-site center service, the user visits the micro-site center and may wait for the vehicle to be serviced. For the in-depth service, the user makes an appointment to the service center after answering a series of questions regarding the malfunction of the AC systems. For the mobile service, the user makes an appointment with a technician and designates the location. In some implementations, operation 185 may make a determination of the selected service based on proximity to the vehicle, i.e., closest to the user's location.

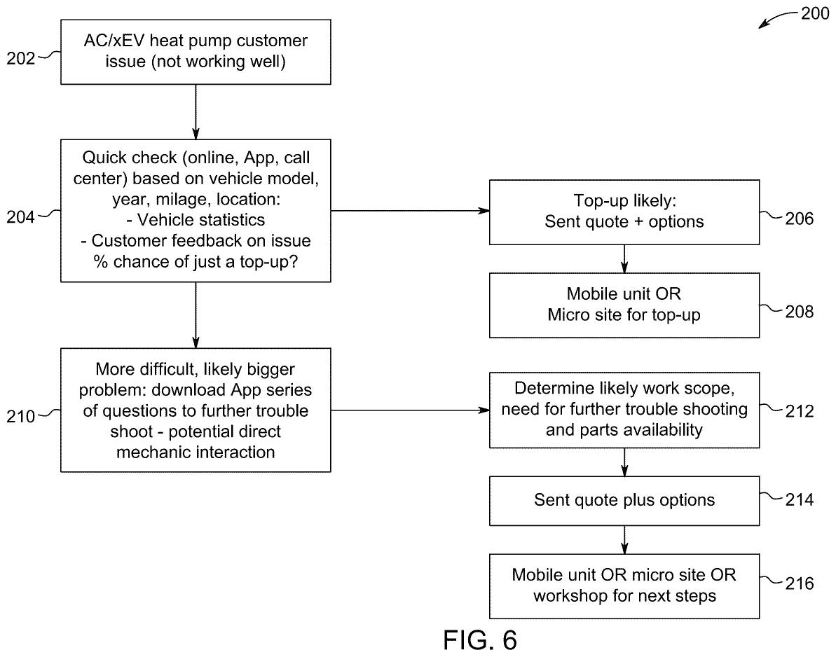

FIG. 6 is a flow chart of a process 200 that illustrates another initial interaction with the user, in accordance with another example embodiment. At step 202, the process indicates identifying an issue associated with the AC systems (e.g., not properly defogging, not properly cooling/heating, error/fault messages, etc.). At step 204, the process performs an initial status check of the AC systems of the vehicle based on at least one of: a basic check (via an app, text, or call the service location) of the vehicle information (e.g., model, year, mileage, and location); a vehicle statistical information (e.g., past historical record of a type of vehicle); and a user's feedback (e.g., not blowing cold/hot air, vibrating, shaking, leaking, making noise, etc.). If the process determines that the vehicle requires only a minor service (i.e., top-up service), the process sends a message to the user that the minor service is recommended and optionally, the message can include a quote, at step 206. At step 208, the process then sends a message to the user whether to take the vehicle to a micro-site for top-up service or arrange for a technician to come out for a mobile service.

If, on the other hand, at step 210, the process determines that the service requires a major AC systems service (i.e., complicated, or more difficult issue requiring expertise and/or equipment), the process sends a series of questions to the user for further trouble shooting. In some implementations, the user can have direct communication with the service location to ascertain the problem. At step 212, when the determined scope of work is the major service, the process formulates the required work and available parts, and optionally sends a quote, at step 214. At step 216, the process then sends a message to the user whether to take the vehicle to a micro-site or arrange for a technician to come out for a mobile service for top-up service or sends a message to a service location for further instructions.

The process describes the initial interaction after the vehicle indicates an issue with the AC systems. The aim is to provide the most efficient solution to resolve the problem based on statistical analysis (i.e., what is the likelihood of a certain problem materializing at a certain vehicle type and build year/plant location) and/or based on user specific information (i.e., location, mileage, problem detail description, last garage visit, etc.). The process also provides a multi-tier solution, i.e., a micro-site location, a mobile solution, and a specialized garage, to the current conventional service available.

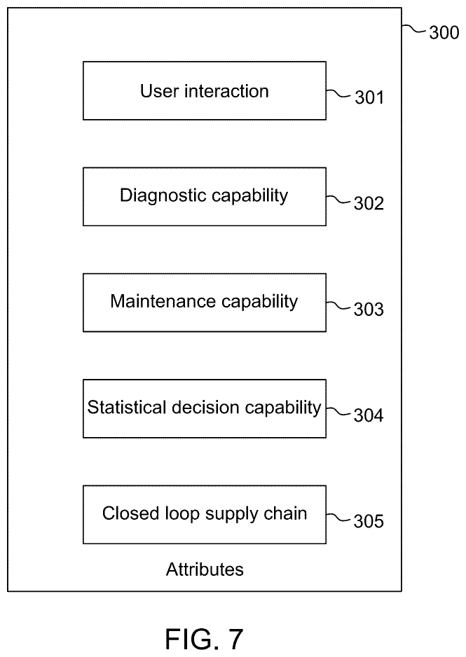

FIG. 7 is a schematic diagram illustrating attributes 300 of the present methods, apparatuses, and systems regarding a fully integrated service offering. As shown in FIG. 10, the attributes 300 may include a user interaction attribute 301, a diagnostics capability attribute 302, a maintenance capability attribute 303, a statistical decision capability attribute 305, and a closed loop supply chain attribute 306 via recycling, reclaiming, and retrofitting and compliance with regulatory directives. Each of these attributes 300 will be discussed in detail below. It should further be appreciated that other attributes may be included besides the one discussed herein.

For user interaction attribute 301, the interaction with the user can be paramount to ensure an effective maintenance to the vehicle and for reducing associated cost. The interaction can be of any communication protocol, such as, but not limited to, an application, text messaging, or directly calling the service location. In some implementations, in an event there is a complicated malfunction to the AC systems, an instruction to download an app is provided for further communication regarding the vehicle and/or service location. In some implementations, information associated with the vehicle, e.g., description of the problem and past maintenance history can be communicated. In some implementations, information associated with the service location can be communicated, e.g., closest authorized service garage, certified technician(s), authorized repair facility, etc. In the event the malfunction is a service call, i.e., a top-up service, the interaction would simply consist of making an appointment for maintenance in one of the service locations via calling or texting.

In some implementations, prior to making the appointment, the interaction with the service location can be associated with a basic information of the vehicle.

For example, when the user connects with the service location through one of the communication protocols, the interaction consists of a few basic questions apart from sharing some general data, such as, for example, the car type and production year. In some implementations, a set of questions can be multi-tiered, i.e., split in several subsets, to optimize an algorithmic engine's decision making and equally the interaction with the user. In one implementation, the questions can be sent to the user in several rounds and the answers can be fed to a statistical engine for analysis. If the diagnose determines no malfunction after the first batch of questions, then no more questions will be posed, and a converged outcome can be shared to the user as the diagnose. If the diagnose cannot be statistically credible after the first batch, another subset of questions will be sent out to the user to further guide the algorithm. This process will be repeated until the algorithm achieves a diagnose with an acceptably low error margin.

One key facet of the user interaction attribute 301 can be data collection.

The collection of data, such as, for example, geography, car type, brand, productions year, mileage, fuel consumption and battery range for EV will be crucial for the working of the diagnostics platform. In some implementations, a micro aggregation of these data can be used to distinct between prevalence of certain issues for a particular region. For example, northern Europe (having generally a colder weather) vs. southern Europe (having generally a warmer weather) may have different, distinct issues relating to AC systems. In some implementations, a condensed macro trends driven by the data collection will enable a provision of curtailed diagnostics on a micro-level. For example, cars of certain brand of a particular year have a higher prevalence of component failure. In other words, cars of brand A/B have high leakage rates and require maintenance after y years (e.g., after the original equipment warranty has expired).

Another facet of the user interaction attribute 301 is a communication with the user to ensure that the performed maintenance was indeed successful. The present process enables a ‘deep-dive’ diagnostic so as to resolve underlying issues of the vehicle, instead of merely performing a ‘temporary fix’. In order to validate that this is indeed the case, the user can give feedback about the repair in function of time, for example. Moreover, users can additionally benefit from preemptive maintenance offerings via app or text message, such as, but not limited to refilling of compressor oil, cleaning or replacing air filtration system, replacing thermostat, deep anti-bacterial cleaning, etc.

For diagnostic capability attribute 302, the process, via a diagnostic engine, provides full transparency to the user. From the initial interaction, the goal will be to provide the most precise diagnose possible and optionally corresponding cost estimation. The diagnose process is closely interlinked with the data collection and statistical model.

In one implementation, after the diagnose has been determined and the user has been informed, the user can make an appointment to service the AC systems of the vehicle. The diagnostics engine can propose an appointment at one of three service types, e.g., in-depth service, a micro-site service, or mobile service. The proposed service will be dependent upon the outcome diagnosis and user preference. Furthermore, the diagnostic engine can process for optimized time, distance, and expertise in specific areas of the vehicle. For example, user who would need more detailed analysis and component replacements will be instructed to an in-depth repair shop while users who require a basis service (i.e., top-up service) will be instructed to a micro-site location or optionally a mobile servicing. As discussed above, during the mobile servicing, a specialized mobile unit (e.g., van) can travel to the user's location (e.g., office, home, etc.) and perform the maintenance in situ.

The maintenance capability attribute 303 can be split into three tiers so that proximity to the user is utilized and user experience is as seamless as possible. For example, the three service options can be a mobile unit service, a micro-site location service, and an in-depth diagnostic shop service. The three proposed service options will have varying degree of equipment and capabilities to perform needed maintenance works, diagnostics, and data reading.

In the exemplary mobile unit service option, the mobile unit service can include a mobile unit (e.g., van) that is equipped with a refrigerant equipment for recharge, recover, and recycle (RRR). In one implementation, the RRR equipment can be locked in place inside of the mobile unit. In another implementation, the RRR equipment can be configured to be movable or portable. For example, the RRR equipment can be removed from the mobile unit and moved closer to the vehicle requiring service if the mobile unit cannot be parked sufficiently close to the vehicle. In some implementations, the RRR machine can have long hoses to access several vehicles at once. In some implementations, the mobile unit can also be equipped with adequate power supply for the RRR machine and/or power supply or computing power for a connected application or a computer.

In some implementations, the mobile unit can be operated by a trained technician and can be configured to perform light work, such as, but not limited to, refrigerant refilling and minor repairs. In some implementations, the computer built inside the mobile unit enables the computer to collect health condition information of the AC/heat pump systems via an on-board computing reading via the diagnostics engine (e.g., vehicle information that enables a more accurate diagnose regarding the AC/heat pump condition). This will allow the technical to perform trouble shooting and diagnose while on-site. In some implementations, the mobile unit can also carry additional equipment and/or working materials, such as, for example consumables, filters, seals, fluids (e.g., engine oil, coolant, windshield washer fluid, power steering fluid, transmission oil, etc.) and some spare parts for minor repairs and/or service.

In some implementations, the technician can provide and obtain all information associated with the vehicle and/or user via the app. For example, information can include a user's created profile at a time of initial registration, basic information of the vehicle (e.g., make, model, year, and production year) and any follow up conversation or data of findings of the status of the AC systems of the vehicle. In some implementations, the app can provide for planning (i.e., appointment scheduling) of the technician. In some implementations, the app can communicate a location of the technician to the user (in case the technician has difficulties in finding the location of the user). Moreover, in case of any delays, the app can immediately communicate the delay, whereby the technician can propose different solutions (e.g., a re-booking of an appointment) directly to the user.

In the exemplary micro-site location service option, the micro-site location service is an alternative to the mobile unit service. By way of example, the micro-site location can be conveniently located in a shopping mall parking garage, car wash, office location, or entertainment location. The micro-site location can be relatively basic, in that, the focus is on performing the same type of services as the mobile unit but at a fixed location, so it can be more easily accessible for the user. This provides an on-demand access to AC services. In one implementation, the user can visit the shopping mall and drop off the vehicle at the micro-site location and shop while service is being performed on for time saving. The user picks up the vehicle afterwards once the vehicle is completely serviced. The performed services at the micro-site location service are similar to the mobile unit service, which can include light work, such as, but not limited to, refrigerant refilling and minor repairs.

In the exemplary in-depth diagnostic shop service option, the in-depth diagnostic shop service is used when the problems of the AC systems cannot be resolved through the earlier two options: the mobile visit or the micro-site location.

The problem can be due to the fact the issue at hand is more complicated or the issue is uncommon that the diagnostic engine is not able to determine the correct underlying cause (i.e., statistical data cannot be formulated). Other problems can be attributable, such as the physical condition of the vehicle for assessment of the AC systems. For example, a collision or an impediment (e.g., stone) impact may cause problems in the AC systems, which may require heavier repair service. In these cases, the user will be redirected to one of the in-depth diagnostics workshops.

These in-depth diagnostics workshops are heavier equipped and encompass expert technicians so that more demand diagnostical and maintenance work can be performed. In some implementations, the diagnostic can be translated into data (and stored) and fed to the diagnostics engine so that it learns from the problems and is able to identify the right diagnose earlier with more precision in future occurrences.

In some implementations, the in-depth diagnostics workshops can also be operated by multiple technicians or multiple workshops. Given the more extensive nature of the work, it may be possible that the user would need to leave the vehicle 26 in the service locations for more than one day or at different locations. In this case, the user interaction attribute 301 informs the user regarding the timing of complete repair and the location of the vehicle, if at a different workshop location.

The statistical decision capability attribute 304 is data driven that collects data regarding the vehicle and stored in a statistical engine. In some implementations, the data collected relates to a type of AC systems problems, problems associated to a particular type of vehicle (i.e., model, year, production facility), occurrence of problems, etc. The data is translated and fed to the diagnostics engine so that it learns from these occurrences and is able to identify the right diagnose earlier and delivers the corresponding work repair with more precision in future events.

The closed loop supply chain attribute 305 concerns with regulatory directives and environmental impact. More specifically, the closed loop supply chain attribute 305 is associated with the recycling, reclaiming, and retrofitting of refrigerant material. Typically, fluorinated gases required for AC and heat pump functionality require significant amounts of energy to produce. These gases can therefore be considered a high value material, especially due to the high efficiency to transport heat. It is therefore desirable to preserve the material as much as possible and promote recycling, reclaiming and retrofitting, and reduce the environmental impact on a CO₂ basis.

Due to the direct user contact, hence full vertical integration of a supply chain, the refrigerant quality can be checked during every service visit. In case the refrigerant in the vehicle is of bad quality or contaminated, the refrigerant will be removed and reclaimed (stripped of any impurities brought up to the required quality level). This constant monitoring, via the statistical analysis approach, of the refrigerant quality is key to tracking illegal imports of refrigerant materials. This will also help over time to predict the risk of illegal refrigerant material being present in a certain vehicle that has been used in a certain geography.

As for retrofitting the refrigerant, the automotive industry has gone through a transition from R-134a to R-1234yf. This transition started in 2012, but only became into force via strict legislation in 2017. This means that certain vehicles on the road today that were produced between 2012 and 2017 have AC equipment installed that can use R-1234yf but are filled with R-134a. This offers an opportunity to retrofit these vehicles with R-1234yf and recycle the R-134a in an application that is not yet capable to use R-1234yf technology. In some implementations, hardware retrofit packages will likely be developed that can convert R-134a AC equipment to R-1234yf in various mobile applications.

In one embodiment retrofitting the refrigerant hardware retrofit packages can convert R-134a AC equipment to handle E-1,3,3,3-tetrafluoropropene composition containing E-1,3,3,3-tetrafluoropropene composition in an amount of 50.0 wt. % or more, preferably in an amount of 75.0 wt. % or more, more preferably in an amount of 99.0 wt. % or more, even more preferably in an amount of 99.5 wt. % or more, and most preferably in an amount of 99.8 wt. % or more, based on the total weight of the fluoropropene composition.

In one embodiment retrofitting the refrigerant hardware retrofit packages can convert R-134a AC equipment to handle E-1,3,3,3-tetrafluoropropene composition containing E-1,3,3,3-tetrafluoropropene composition, as disclosed herein, and the total amount of 2,3,3,3-tetrafluoropropene and 1,1,3,3,3-pentafluoropropene in the fluoropropene composition is 0.001 to 0.9 wt. %, preferably is 0.1 to 0.8 wt. %, and most preferably is 0.3 to 0.5 wt. % based on the total weight of the fluoropropene composition.

In one embodiment retrofitting the refrigerant hardware retrofit packages can convert R-134a AC equipment to handle E-1,3,3,3-tetrafluoropropene composition which additionally comprises R-134, preferably in an amount of 1.0 to 40.0 wt. %, more preferably in an amount of 30.0 to 40.0 wt. %, and most preferably in an amount of 35.0 to 40.0 wt. % based on the total weight of the fluoropropene composition.

In one embodiment retrofitting the refrigerant hardware retrofit packages can convert R-134a AC equipment to handle E-1,3,3,3-tetrafluoropropene composition which additionally comprises R-1336mzzE and/or R-227ea, preferably in an amount of 15.0 to 20.0 wt. % of R-1336mzzE and of 2.0 to 5.0 wt. % of R-227ea based on the total weight of the fluoropropene composition.

In one embodiment retrofitting the refrigerant hardware retrofit packages can convert R-134a AC equipment to handle a composition comprising HFO-E-1234ze and HFC-227ea. In one embodiment, the composition comprises HFO-E-1234ze and up to 15 wt. % HFC-227ea, preferably from 8 to 13 wt. % HFC-227ea, based on the total weight of the composition. In one embodiment, the composition comprises 88 wt. % HFO-E-1234ze and 12 wt. % HFC-227ea, based on the total weight of the composition. In one embodiment, the composition comprises 91.1 wt. % HFO-E-1234ze and 8.9 wt. % R-227ea, based on the total weight of the composition.

In one embodiment retrofitting the refrigerant hardware retrofit packages can convert R-134a AC equipment to handle a composition comprising HFO-E-1234ze and HFC-152a. In one embodiment, the composition comprises HFO-E-1234ze and up to 20 wt. % HFC-152a, preferably from 1 to 20 wt. % HFC-152a, based on the total weight of the composition.

In one embodiment retrofitting the refrigerant hardware retrofit packages can convert R-134a AC equipment to handle a composition comprising HFO-E-1234ze, HFC-32, and HFC-152a. In one embodiment, the composition comprises HFO-E-1234ze and up to about 15 wt. % HFC-32 and up to about 10 wt. % HFC-152a, based on the total weight of the composition. In one embodiment, the composition comprises 83 wt. % HFO-E-1234ze, 12 wt. % HFC-32 and 5 wt. % HFC-152a, based on the total weight of the composition.

In one embodiment retrofitting the refrigerant hardware retrofit packages can convert R-134a AC equipment to handle a composition comprising HFO-E-1234ze, HFC-32, and HFC-134a. In one embodiment, the composition comprises HFO-E-1234ze and up to about 10 wt. % HFC-32 and up to about 50 wt. % HFC-134a, based on the total weight of the composition. In one embodiment, the composition comprises 49 wt. % HFO-E-1234ze, 6 wt. % HFC-32 and 45 wt. % HFC-134a, based on the total weight of the composition.

In one embodiment retrofitting the refrigerant hardware retrofit packages can convert R-134a AC equipment to handle a composition comprising HFO-E-1234ze, CO₂, and HFC-134a. In one embodiment, the composition comprises HFO-E-1234ze and up to about 10 wt. % CO₂ and up to about 15 wt. % HFC-134a, based on the total weight of the composition. In one embodiment, the composition comprises 85 wt. % HFO-E-1234ze, 6 wt. % CO₂ and 9 wt. % HFC-134a, based on the total weight of the composition.

In one embodiment retrofitting the refrigerant hardware retrofit packages can convert R-134a AC equipment to handle E-1,3,3,3-tetrafluoropropene composition which additionally and optionally comprises one or more of R-143a, R-152a, TFP (trifluoropropyne), R-1233xf, R-1233zd(E), R-1233zd(Z), R236fa, and at least one HFO-1234 isomer including at least one of HFO-1234zc, HFO-1234yc and HFO-1234ye.

In one embodiment retrofitting the refrigerant hardware retrofit packages can convert R-134a AC equipment to handle E-1,3,3,3-tetrafluoropropene composition in which the sum total additional compounds selected from one or more of R-143a, R-152a, TFP, R-1233xf, R-1233zd(E), and R-1233zd(Z) is present in amounts of between 0.001 mole percent and 2 mole percent, based on the total fluoropropene composition.

The data collected, via the statistical engine, enables a quick identification of a vehicle that would potentially qualify for such a retrofit when the user is requesting a service. The basic information like vehicle year, make, model, geographic location can provide a likelihood that the vehicle qualifies for a retrofit.

Further, via the user interaction attribute 301, the system can investigate user interest and ensure that the required materials are available when the user arrives at the service location.

The closed loop supply chain attribute 305 also concerns with overall supply chain management. In one implementation, the overall supply chain management can statistically determine where do we find most of the vehicles geographically with similar AC systems problems. Using this data, the system can determine the corrective course of action and suggestive recommendations repairs relating to that particular vehicle based on geographical location.

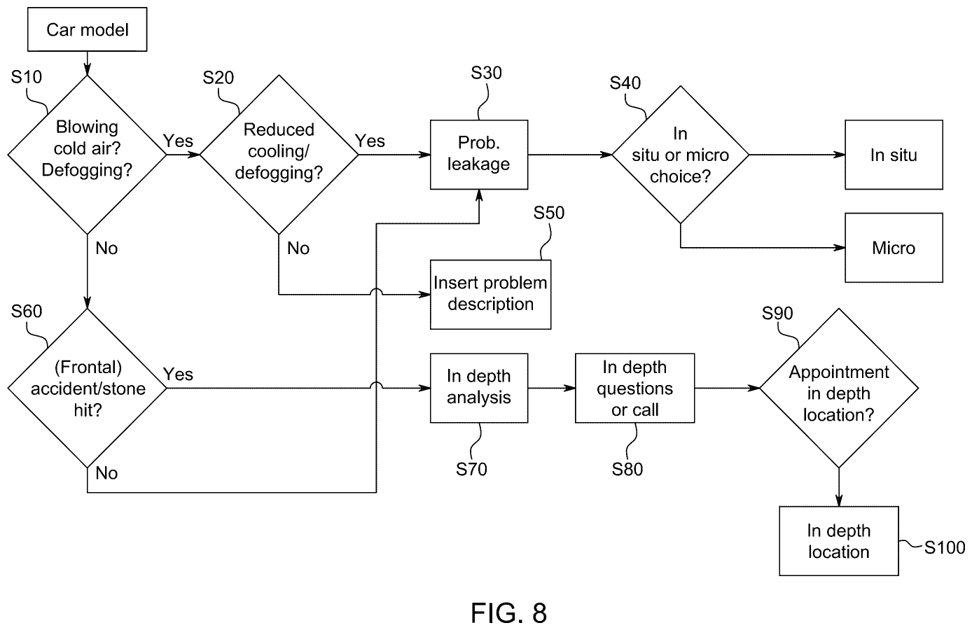

FIG. 8 illustrates an exemplary diagnostic decision process by a diagnostic engine (i.e., diagnostic module 153) based on data, statistics and validation to guide the user and to perform maintenance in the most cost efficient and effective manner. As shown in FIG. 10, after receiving the basic information of the vehicle (e.g., year, make, model, etc.), the diagnostic decision process determines whether the AC systems is blowing cold air or defogging properly (S10). If no, the diagnostic decision process determines that the AC systems is not properly blowing cold air or properly defogging (S60), caused by, for example, a frontal accident to the vehicle or an impediment hitting the vehicle, and determines whether to perform an in-depth analysis (S70), which will be discussed later herein. If yes, the diagnostic decision process then determines whether the blown cold air is at a reduced rate or not at predetermined temperature (S20). If the blown cold air is operating at a reduced rate or predetermined temperature, the process determines that there is a refrigerant leak in the system and requires at least a top-up service (S30). If, however, it is determined that the blown cold air is not at a reduced rate or at the predetermined temperature, the process requests the user to describe the problem in further detail to possible be directed for an in-depth analysis (S70). After determination of the refrigerant leak, the diagnostic decision process can determine whether to perform an in-situ (e.g., mobile service) or a micro-site service (S40). Referring back to S60, the diagnostic decision process determines that the AC systems is not properly blowing cold air or properly defogging, caused by for example, a frontal accident to the vehicle or impediment hitting the vehicle. If the problem of the AC systems is not caused by the frontal accident or impediment impact, the process determines most likely that the problem is a refrigerant leak and requires a top-up service (S30). If the problem of the AC systems is caused by the frontal accident or impediment impact, the process moves to an in-depth analysis (S70) and requires further investigation by either asking several questions regarding the problem or speaking to the user directly (S80). Subsequently, the process can schedule an appointment (S90) to bring the vehicle to an in-depth service workshop (S100).

FIG. 9 is a schematic diagram of a computer system 900. The system 900 can be used to carry out the operations described in association with any of the computer-implemented methods described previously, according to some implementations. For example, storage device 930 of system 900 can store instructions that are executable by one or more processing devices 910 to perform operations of the diagnostic module 153, the service type determination module 154, the vehicle location module 155, the inventory/spare parts module 156, and/or the statistical module 157.

In some implementations, computing systems and devices and the functional operations described in this specification can be implemented in digital electronic circuitry, in tangibly-embodied computer software or firmware, in computer hardware, including the structures disclosed in this specification (e.g., system 900) and their structural equivalents, or in combinations of one or more of them. The system 900 is intended to include various forms of digital computers, such as laptops, desktops, workstations, personal digital assistants, servers, blade servers, mainframes, and other appropriate computers, including vehicles installed on base units or pod units of modular vehicles. The system 900 can also include mobile devices, such as personal digital assistants, cellular telephones, smartphones, and other similar computing devices. Additionally, the system can include portable storage media, such as, Universal Serial Bus (USB) flash drives. For example, the USB flash drives may store operating systems and other applications. The USB flash drives can include input/output components, such as a wireless transducer or USB connector that may be inserted into a USB port of another computing device.

The system 900 includes a processing device or processor 910, a memory 920, a storage device 930, and an input/output device 940. Each of the components 910, 920, 930, and 940 are interconnected using a system bus 950. The processor 910 is capable of processing instructions for execution within the system 900. The processor may be designed using any of a number of architectures. For example, the processor 910 may be a CISC (Complex Instruction Set Computers) processor, a RISC (Reduced Instruction Set Computer) processor, or a MISC (Minimal Instruction Set Computer) processor.

In one implementation, the processor 910 is a single-threaded processor. In another implementation, the processor 910 is a multi-threaded processor. The processor 910 is capable of processing instructions stored in the memory 920 or on the storage device 930 to display graphical information for a user interface on the input/output device 940.

The memory 920 stores information within the system 900. In one implementation, the memory 920 is a computer-readable medium. In one implementation, the memory 920 is a volatile memory unit. In another implementation, the memory 920 is a non-volatile memory unit.

The storage device 930 is capable of providing mass storage for the system 900. In some implementations, storage device 930 is a hardware-based storage device. In one implementation, the storage device 930 is a computer-readable medium. In various different implementations, the storage device 930 may be a floppy disk device, a hard disk device, an optical disk device, or a tape device.

The input/output device 940 provides input/output operations for the system 900. In one implementation, the input/output device 940 includes a keyboard and/or pointing device. In another implementation, the input/output device 940 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random-access memory or both. The essential elements of a computer are a processor for executing instructions and one or more memories for storing instructions and data.

Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits). The machine learning model can run on Graphic Processing Units (GPUs) or custom machine learning inference accelerator hardware.

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet. The computer system can include clients and servers. A client and server are generally remote from each other and typically interact through a network, such as the described one. The relationship of client and server arises by virtue of computer programs running on the respective computers and having a client-server relationship to each other.

In some implementations, the present disclosure provides a business model that can be organized regionally. In other words, the business model tailors a specific marketing communication strategy that meets regional needs and brand recognition as well as being able to offer users a good service with sufficient user proximity. In addition, when scaling up the business model, it offers the opportunity to trial and test quicker to finetune the business model.

As used herein, the term “user” can be designated as a user, an operator, an owner of the vehicle, a user, a fleet user, an owner of fleet vehicles, etc.

### EMBODIMENTS

A. A method includes receiving a malfunction indication associated with a thermal system of a vehicle, determining whether the malfunction indication is related to servicing the thermal system, determining a multi-tiered service option for servicing the thermal system wherein the multi-tiered service option includes at least one of a mobile service, a micro-site service, or a full-service, selecting one of the multi-tiered service option, wherein the selection is based at least in part on statistical data relating to prior malfunctions associated with the vehicle, and scheduling the selected multi-tiered service option to perform service on the thermal system of the vehicle.
B. The method of Embodiment A, wherein the thermal system is associated with an AC system of an internal combustion engine vehicle.
C. The method of Embodiment A, wherein the thermal system is associated with a heat pump of an electric vehicle.
D. The method of Embodiment A, further comprising sending a cost estimate after determining the malfunction indication is related to servicing the thermal system.
E. The method of Embodiment D, wherein sending the cost estimate further comprises responding to a set of questions relating to the malfunction and the vehicle.
F. The method of Embodiment A, wherein the malfunction indicator is based on user interface.
G. The method Embodiment F, wherein the user interface includes at least one of a determination of: an indication of warm air, an indication of cold air at a reduced rate, or an indication of defogging function improperly working.
H. The method of Embodiment A, wherein the received malfunction indicator is based on measured readings of condition indicators via sensors.
I. The method of Embodiment A, wherein the condition indicators include at least one of a fuel efficiency sensor, a temperature sensor, or a battery charge sensor.
J. The method of Embodiment A, further comprising receiving information associated with the vehicle, wherein the received information includes at least one of year, make, model, mileage, or location of the vehicle.
K. The method of Embodiment A, wherein the mobile service option or the micro-site service option is configured to perform minor services to the thermal system of the vehicle.
L. The method of Embodiment A, wherein the minor services include at least replacing and refilling refrigerant from the vehicle.
M. The method of Embodiment A, wherein the full-service option is configured to perform minor services or major services.
N. The method of Embodiment A, further comprising sending a diagnostic report of the thermal system regarding the malfunction indication.
O. The method of Embodiment A, further comprising sending additional work options to service the vehicle.
P. A method includes receiving data associated with a thermal system of a vehicle, determining at least one thermal system issue associated with the vehicle based at least in part on the data, analyzing the data to determine a solution to the at least one thermal system issue, providing a service option from at least three options to service the at least one AC systems issue, and determining a service location based on the provided service option.
Q. A system including one or more processors, and one or more non-transitory computer readable storage media communicatively coupled to the one or more processors and storing instructions that are executable by the one or more processors to receive a malfunction indication associated with a thermal system of a vehicle, determine whether the malfunction indication is related to servicing the thermal system, determine a multi-tiered service option for servicing the thermal system wherein the multi-tiered service option includes at least one of a mobile service, a micro-site service, or a full-service, selecting one of the multi-tiered service option, wherein the selection is based at least in part on statistical data relating to prior malfunctions associated with the vehicle, and schedule the selected multi-tiered service option to perform service on the thermal system of the vehicle.
R. A system, including one or more processors, and one or more non-transitory computer readable storage media communicatively coupled to the one or more processors and storing instructions that are executable by the one or more processors to receive a malfunction indication associated with a thermal system of a vehicle, determine whether the malfunction indication is related to servicing the thermal system, determine a multi-tiered service option for servicing the thermal system wherein the multi-tiered service option includes at least one of a mobile service, a micro-site service, or a full-service, selecting one of the multi-tiered service option, wherein the selection is based at least in part on statistical data relating to prior malfunctions associated with the vehicle, and schedule the selected multi-tiered service option to perform service on the thermal system of the vehicle.
S. The method of Embodiment A, wherein the statistical data includes age, brand, mileage, and maintenance history of the vehicle.
T. The system of Embodiment Q, wherein the statistical data includes age, brand, mileage, and maintenance history of the vehicle.
U. The system of Embodiment R, wherein the statistical data includes age, brand, mileage, and maintenance history of the vehicle.
V. The method of Embodiment L, wherein the replacement refrigerant comprises a fluoroolefin composition comprising E-1,3,3,3-tetrafluoropropene (HFO-1234ze(E), between greater than 0 and less than 0.2 weight percent Z-1,3,3,3-tetrafluoropropene (HFO-1234ze(Z), 2,3,3,3-tetrafluoropropene (HFO-1234yf), at least one of HCFO-1336mzz(E) and HFC-227ea, and at least one additional member comprising HFC-245cb, HFO-1225ye (E/Z), and HFO-1233zd (E/Z).
W. The method of Embodiment V, wherein the replacement refrigerant comprising greater than 0 and less than 500 ppm Z-1,3,3,3-tetrafluoropropene based on the total fluoropropene composition, E 1,3,3,3-tetrafluoropropene, E-1336mzz, and between 0.00001 to 5 mol% 2,3,3,3-tetrafluoropropene (HFO-1234yf) based on the total fluoropropene composition, and further comprising at least one of R-134a, R-227a, R-1225ye and R-1233zd.
X. The method of Embodiment V wherein the replacement refrigerant comprising at least 75 wt. % E-1,3,3,3-tetrafluoropropene (HFO-1234ze(E)) based on the total weight of the composition, Z-1,3,3,3-tetrafluoropropene (HFO-1234ze(Z)), the at least one additional member(s) is selected from one of:
   (a) HFO-1234yf and HFO-1225zc,
   (b) HFO-1234yf and HFO-1225ye
   (c) HFO-1225zc and HFO-1225ye
   (d) HFO-1234yf, HFO-1225zc, and HFO-1225ye,
   (e) R-114 and R-124,
   (f) R-114, R-124 and HFC-227,
   (g) (v)+(i), (ii), (iii) or (iv), and,
   (h) (vi)+(i), (ii), (iii) or (iv).
Y. The method of Embodiment L, wherein the replacement refrigerant comprising an E 1,3,3,3-tetrafluoropropene blend selected from one of R444A/B, R445A, R446A/B, R447B, R448A, R450A, R456A, R459A/B, R460A/B/C, R464A, R515A and R515B, and optionally further comprising at least one additional compound selected from HFO-Z-1234ze, HFC-245fa, HFC-236fa, HFO-E1225ye and 1225yeZ.
Z. The method of Embodiment L, wherein the replacement refrigerant comprising 1,3,3,3-tetrafluoropropene blend selected from one of R444A/B, R446A/B, R447B, R448A, and one or more additional compound selected from HFC-125, HFC-134, HFC-134a, HFC-245cb, HFO-1225zc, HFO-1243zf and HFO-1234yf, and optionally HFO-Z-1234ze.
AA. The method of Embodiment L, wherein the replacement refrigerant comprising E 1,3,3,3-tetrafluoropropene (HFO-E-1234ze), difluoromethane(HFC-32), 1,1, difluoromethane (HFC-152a), (i) one or more additional compound selected from HFC-125, HFC-134, HFC-134a, HFC-245cb, HFO-1225zc, HFO-1243zf and HFO-1234yf wherein based on the total weight of the composition, between 5% by weight and 95% E 1,3,3,3-tetrafluoropropene is present, between 95% by weight and 5% by weight of HFC-32 and HFC-152a are present, and the total amount of the one or more additional compounds is between greater than 0 to less than about 1% by weight such that the total amount of the fluoropropene composition is 100%.
BB. The method of Embodiment L, wherein the replacement refrigerant is a composition comprising E-1,3,3,3-tetrafluoropropene (HFO-E-1234ze) and HFC-227ea, preferably up to 15 wt. % HFC-227ea, more preferably from 8 to 13 wt. % HFC-227ea, based on the total weight of the composition. Preferably, the composition comprises 88 wt. % HFO-E-1234ze and 12 wt. % HFC-227ea, based on the total weight of the composition. Preferably, the composition comprises 91.1 wt. % HFO-E-1234ze and 8.9 wt. % R-227ea, based on the total weight of the composition.
CC. The method of Embodiment L, wherein the replacement refrigerant is a composition comprising HFO-E-1234ze and HFC-152a, preferably up to 20 wt. % HFC-152a, more preferably from 1 to 20 wt. % HFC-152a, based on the total weight of the composition.
DD. The method of Embodiment L, wherein the replacement refrigerant is a composition comprising HFO-E-1234ze, HFC-32, and HFC-152a, preferably up to about 15 wt. % HFC-32 and preferably up to about 10 wt. % HFC-152a, based on the total weight of the composition. Preferably, the composition comprises 83 wt. % HFO-E-1234ze, 12 wt. % HFC-32 and 5 wt. % HFC-152a, based on the total weight of the composition.

EE. The method of Embodiment L, wherein the replacement refrigerant is a composition comprising HFO-E-1234ze, HFC-32, and HFC-134a, preferably up to about 10 wt. % HFC-32 and preferably up to about 50 wt. % HFC-134a, based on the total weight of the composition. Preferably, the composition comprises 49 wt. % HFO-E-1234ze, 6 wt. % HFC-32 and 45 wt. % HFC-134a, based on the total weight of the composition.
FF. The method of Embodiment L, wherein the replacement refrigerant is a composition comprising HFO-E-1234ze, CO₂, and HFC-134a, preferably up to about 10 wt. % CO₂ and preferably up to about 15 wt. % HFC-134a, based on the total weight of the composition. Preferably, the composition comprises 85 wt. % HFO-E-1234ze, 6 wt. % CO₂ and 9 wt. % HFC-134a, based on the total weight of the composition.
GG. The method of any of Embodiments L and V to FF, wherein the composition further comprises an effective amount of at least one inhibitor which reduces conversion of the fluoroolefin into oligomers or polymers.
HH. The method of Embodiment GG, wherein the composition contains less than 1 wt. % of oligomeric, homopolymers or other polymeric products, preferably less than about 0.03 wt. % of oligomeric, homopolymers or other polymeric products.
II. The method of any of Embodiments GG to HH, wherein the inhibitor comprises at least one member selected from the group consisting of limonene, a-terpinene, a-tocopherol, butylated hydroxytoluene, 4-methoxyphenol, and benzene-1,4-diol.
JJ. The method of any of Embodiments GG to II, wherein the inhibitor is at least one of limonene and a-terpinene.
KK. The method of any of Embodiments GG to JJ, wherein the inhibitor is present in an amount of about 30 to about 3,000 ppm.

The following represent further preferred items of the invention:
1. A method, comprising:
   receiving a malfunction indication associated with a thermal system of a vehicle;
   determining whether the malfunction indication is related to servicing the thermal system (e.g., determining the diagnose based on data collection and an statistical engine);
   determining a multi-tiered service option for servicing the thermal system wherein the multi-tiered service option includes at least one of a mobile service, a micro-site service, or a full-service;
   selecting one of the multi-tiered service option, wherein the selection is based at least in part on statistical data relating to prior malfunctions associated with the vehicle (e.g., and in some cases also employing profile matching with other statistical data in the data base); and
   scheduling the selected multi-tiered service option to perform service on the thermal system of the vehicle.
2. The method of item 1, wherein the thermal system is associated with an AC system of an internal combustion engine vehicle.
3. The method of item 1, wherein the thermal system is associated with a heat pump of an electric vehicle.
4. The method of item 1, 2 or 3, further comprising sending a cost estimate after determining the malfunction indication is related to servicing the thermal system.
5. The method of item 4, wherein sending the cost estimate further comprises responding to a set of questions relating to the malfunction and the vehicle.
6. The method of any one of items 1 to 5, wherein the malfunction indicator is based on user interface.
7. The method of item 6, wherein the user interface includes at least one of a determination of: an indication of warm air, an indication of cold air at a reduced rate, or an indication of defogging function improperly working.
8. The method of any one of items 1 to 7, wherein the received malfunction indicator is based from measured readings of condition indicators via sensors.
9. The method of item 8, wherein the condition indicators include at least one of a fuel efficiency sensor, a temperature sensor, or a battery charge sensor.
10. The method of any one of items 1 to 9, further comprising receiving information associated with the vehicle, wherein the received information includes at least one of year, make, model, mileage, or location of the vehicle.
11. The method of any one of items 1 to 10, wherein the mobile service option or the micro-site service option is configured to perform minor services to the thermal system of the vehicle.
12. The method of item 11, wherein the minor services include at least replacing and refilling refrigerant from the vehicle.
13. The method of any one of items 1 to 12, wherein the full-service option is configured to perform minor services or major services.
14. The method of any one of items 1 to 13, further comprising sending a diagnostic report of the thermal system regarding the malfunction indication.
15. The method of any one of items 1 to 14, further comprising sending additional work options to service the vehicle.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method, comprising:
receiving a malfunction indication associated with a thermal system of a vehicle;
determining whether the malfunction indication is related to servicing the thermal system;
determining a multi-tiered service option for servicing the thermal system wherein the multi-tiered service option includes at least one of a mobile service, a micro-site service, or a full-service;
selecting one of the multi-tiered service option, wherein the selection is based at least in part on statistical data relating to prior malfunctions associated with the vehicle; and
scheduling the selected multi-tiered service option to perform service on the thermal system of the vehicle.

2. The method of claim 1, wherein the thermal system is associated with an AC system of an internal combustion engine vehicle.

3. The method of claim 1, wherein the thermal system is associated with a heat pump of an electric vehicle.

4. The method of claim 1, further comprising sending a cost estimate after determining the malfunction indication is related to servicing the thermal system.

5. The method of claim 4, wherein sending the cost estimate further comprises responding to a set of questions relating to the malfunction and the vehicle.

6. The method of claim 1, wherein the malfunction indicator is based on user interface.

7. The method of claim 6, wherein the user interface includes at least one of a determination of: an indication of warm air, an indication of cold air at a reduced rate, or an indication of defogging function improperly working.

8. The method of claim 1, wherein the received malfunction indicator is based from measured readings of condition indicators via sensors.

9. The method of claim 8, wherein the condition indicators include at least one of a fuel efficiency sensor, a temperature sensor, or a battery charge sensor.

10. The method of claim 1, further comprising receiving information associated with the vehicle, wherein the received information includes at least one of year, make, model, mileage, or location of the vehicle.

11. The method of claim 1, wherein the mobile service option or the micro-site service option is configured to perform minor services to the thermal system of the vehicle.

12. The method of claim 11, wherein the minor services include at least replacing and refilling refrigerant from the vehicle.

13. The method of claim 1, wherein the full-service option is configured to perform minor services or major services.

14. The method of claim 1, further comprising sending a diagnostic report of the thermal system regarding the malfunction indication.

15. The method of claim 1, further comprising sending additional work options to service the vehicle.

16. A method, comprising:
receiving data associated with a thermal system of a vehicle;
determining at least one thermal system issue associated with the vehicle based at least in part on the data;
analyzing the data to determine a solution to the at least one thermal system issue;
providing a service option from a plurality of options to service the at least one thermal system issue; and
determining a service location based on the analyzed data.

17. A system, comprising:
one or more processors; and
one or more non-transitory computer readable storage media communicatively coupled to the one or more processors and storing instructions that are executable by the one or more processors to:
receive a malfunction indication associated with a thermal system of a vehicle;
determine whether the malfunction indication is related to servicing the thermal system;
determine a multi-tiered service option for servicing the thermal system wherein the multi-tiered service option includes at least one of a mobile service, a micro-site service, or a full-service;
select one of the multi-tiered service option, wherein the selection is based at least in part on statistical data relating to prior malfunctions associated with the vehicle and
schedule the selected multi-tiered service option to perform service on the thermal system of the vehicle.

18. A system, comprising:
one or more processors; and
one or more non-transitory computer readable storage media communicatively coupled to the one or more processors and storing instructions that are executable by the one or more processors to:
receive a malfunction indication associated with a thermal system of a vehicle;
determine whether the malfunction indication is related to servicing the thermal system;
determine a multi-tiered service option for servicing the thermal system wherein the multi-tiered service option includes at least one of a mobile service, a micro-site service, or a full-service;
select one of the multi-tiered service option, wherein the selection is based at least in part on statistical data relating to prior malfunctions associated with the vehicle and
schedule the selected multi-tiered service option to perform service on the thermal system of the vehicle.

19. The method of claim 1 wherein the statistical data includes age, brand, mileage, and maintenance history of the vehicle.

20. The system of claim 17 wherein the statistical data includes age, brand, mileage, and maintenance history of the vehicle.

21. The system of claim 18 wherein the statistical data includes age, brand, mileage, and maintenance history of the vehicle.

22. The method of claim 12 wherein the refrigerant comprises a fluoroolefin composition comprising E-1,3,3,3-tetrafluoropropene (HFO-1234ze(E), between greater than 0 and less than 0.2 weight percent Z-1,3,3,3-tetrafluoropropene (HFO-1234ze(Z), 2,3,3,3-tetrafluoropropene (HFO-1234yf), at least one of HCFO-1336mzz(E) and HFC-227ea, and at least one additional member comprising HFC-245cb, HFO-1225ye (E/Z), and HFO-1233zd (E/Z).

23. A fluoropropene composition of claim 22 comprising greater than 0 and less than 500 ppm Z-1,3,3,3-tetrafluoropropene based on the total fluoropropene composition, E 1,3,3,3-tetrafluoropropene, E-1336mzz, and between 0.00001 to 5 mol% 2,3,3,3-tetrafluoropropene (HFO-1234yf) based on the total fluoropropene composition, and further comprising at least one of R-134a, R-227a, R-1225ye and R-1233zd.

24. A fluoropropene composition of claim 12 comprising at least 75 wt. % E-1,3,3,3-tetrafluoropropene (HFO-1234ze(E)) based on the total weight of the composition, Z-1,3,3,3-tetrafluoropropene (HFO-1234ze(Z)), and at least one additional member selected from one of R-1336mzz(E) (trans-1, 1, 1,4,4,4-hexafluoro-2-butene), HFO-1234yf (2,3,3,3-tetrafluoropropene), HFO-1225zc (1,1,3,3,3-pentafluoropropene), R-114, R-124, R-227ea, R-227ca, R-245cb, E-HFO-1225ye, Z-HFO-1225ye, E-HFO-1233zd, and Z-HFO-1233zd.

25. The fluoropropene composition of claim 12 comprising at least 75 wt. % E-1,3,3,3-tetrafluoropropene (HFO-1234ze(E)) based on the total weight of the composition, Z-1,3,3,3-tetrafluoropropene (HFO-1234ze(Z)), the at least one additional member(s) is selected from one of:
(a) HFO-1234yf and HFO-1225zc,
(b) HFO-1234yf and HFO-1225ye
(c) HFO-1225zc and HFO-1225ye
(d) HFO-1234yf, HFO-1225zc, and HFO-1225ye,
(e) R-114 and R-124,
(f) R-114, R-124 and HFC-227,
(g) (v) +(i), (ii), (iii) or (iv), and,
(h) (vi) +(i), (ii), (iii) or (iv).

26. The fluoropropene composition of claim 12 comprising an E 1,3,3,3-tetrafluoropropene blend selected from one of R444A/B, R445A, R446A/B, R447B, R448A, R450A, R456A, R459A/B, R460A/B/C, R464A, R515A and R515B, optionally further comprising at least one additional compound selected from HFO-Z-1234ze, HFC-245fa, HFC-236fa, HFO-E 1225ye and 1225yeZ.

27. The fluoropropene composition of claim 12 comprising 1,3,3,3-tetrafluoropropene blend selected from one of R444A/B, R446A/B, R447B, R448A, and one or more additional compound selected from HFC-125, HFC-134, HFC-134a, HFC-245cb, HFO-1225zc, HFO-1243zf and HFO-1234yf, and optionally HFO-Z-1234ze.

28. The fluoropropene composition of claim 12 comprising E 1,3,3,3-tetrafluoropropene (HFO-E-1234ze), difluoromethane(HFC-32), 1,1,difluoromethane (HFC-152a), (i) one or more additional compound selected from HFC-125, HFC-134, HFC-134a, HFC-245cb, HFO-1225zc, HFO-1243zf and HFO-1234yf wherein based on the total weight of the composition, between 5% by weight and 95% E 1,3,3,3-tetrafluoropropene is present, between 95% by weight and 5% by weight of HFC-32 and HFC-152a are present, and the total amount of the one or more additional compounds is between greater than 0 to less than about 1% by weight such that the total amount of the fluoropropene composition is 100%.

29. The method of claim 12, wherein the replacement refrigerant is a composition comprising E-1,3,3,3-tetrafluoropropene (HFO-E-1234ze) and HFC-227ea, preferably up to 15 wt. % HFC-227ea, more preferably from 8 to 13 wt. % HFC-227ea, based on the total weight of the composition.

30. The method of claim 29, wherein the replacement refrigerant is composition comprising 88 wt. % HFO-E-1234ze and 12 wt. % HFC-227ea, based on the total weight of the composition.

31. The method of claim 29, wherein the replacement refrigerant is composition comprising 91.1 wt. % HFO-E-1234ze and 8.9 wt. % R-227ea, based on the total weight of the composition.

32. The method of claim 12, wherein the replacement refrigerant is a composition comprising HFO-E-1234ze and HFC-152a, preferably up to 20 wt. % HFC-152a, more preferably from 1 to 20 wt. % HFC-152a, based on the total weight of the composition.

33. The method of claim 12, wherein the replacement refrigerant is a composition comprising HFO-E-1234ze, HFC-32, and HFC-152a, preferably up to about 15 wt. % HFC-32 and preferably up to about 10 wt. % HFC-152a, based on the total weight of the composition.

34. The method of claim 33, wherein the replacement refrigerant is a composition comprising 83 wt. % HFO-E-1234ze, 12 wt. % HFC-32 and 5 wt. % HFC-152a, based on the total weight of the composition.

35. The method of claim 12, wherein the replacement refrigerant is a composition comprising HFO-E-1234ze, HFC-32, and HFC-134a, preferably up to about 10 wt. % HFC-32 and preferably up to about 50 wt. % HFC-134a, based on the total weight of the composition.

36. The method of claim 35, wherein the replacement refrigerant is a composition comprising 49 wt. % HFO-E-1234ze, 6 wt. % HFC-32 and 45 wt. % HFC-134a, based on the total weight of the composition.

37. The method of claim 12, wherein the replacement refrigerant is a composition comprising HFO-E-1234ze, CO₂, and HFC-134a, preferably up to about 10 wt. % CO₂ and preferably up to about 15 wt. % HFC-134a, based on the total weight of the composition.

38. The method of claim 27, wherein the replacement refrigerant is composition comprising 85 wt. % HFO-E-1234ze, 6 wt. % CO₂ and 9 wt. % HFC-134a, based on the total weight of the composition.

39. The method of any of claim 12, wherein the composition further comprises an effective amount of at least one inhibitor which reduces conversion of the fluoroolefin into oligomers or polymers.

40. The method of claim 39, wherein the composition contains less than 1 wt. % of oligomeric, homopolymers or other polymeric products, preferably less than about 0.03 wt. % of oligomeric, homopolymers or other polymeric products.

41. The method of claim 39, wherein the inhibitor comprises at least one member selected from the group consisting of limonene, α-terpinene, α-tocopherol, butylated hydroxytoluene, 4-methoxyphenol, and benzene-1,4-diol.

42. The method of claim 39, wherein the inhibitor is at least one of limonene and α-terpinene.

43. The method of claim 39, wherein the inhibitor is present in an amount of about 30 to about 3,000 ppm.
